(19) United States
(12) Patent Application Publication
(10) Pub. No.: US 2023/0357477 A1
(43) Pub. Date: Nov. 9, 2023

(54) ACRYLAMIDE OR (METH)ACRYLAMIDE-CONTAINING HIGH TG ADDITIVE FOR PRESSURE SENSITIVE ADHESIVES

(71) Applicant: 3M INNOVATIVE PROPERTIES COMPANY, St. Paul, MN (US)

(72) Inventors: Sung-Tso Lin, Taoyuan City (TW); Ching-Yi Liu, Zhunan Township (TW); Ying-Yuh Lu, Woodbury, MN (US); Wei-Cheng Su, Taoyuan Hsien (TW)

(21) Appl. No.: 18/246,364

(22) PCT Filed: Oct. 5, 2021
(86) PCT No.: PCT/IB2021/059130

§ 371 Date: Mar. 23, 2023

Related U.S. Application Data
(60) Provisional application No. 63/088,119, filed on Oct. 6, 2020.

(51) Int. Cl. C08F 265/10; C09J 151/00

(52) U.S. Cl. CPC C08F 265/10; C09J 151/003

(57) ABSTRACT

The present application is a composition including abase resin comprising between about 4% and about 15% acrylic acid monomer and an oligomer additive comprising (a) one of an acrylamide or meth(acrylamide) copolymer and (b) a high glass transition temperature monomer. The oligomer additive has a molecular weight range of between about 20,000 and about 1,000,000 and a glass transition temperature of between about 70° C. and about 115° C. The composition has a blending ratio of base resin to oligomer additive of between about 7 to about 30 parts per hundred of resin.

### FIELD OF INVENTION

The present invention is related generally to the field of pressure sensitive adhesives. In particular, the present invention is a pressure sensitive adhesive having an acrylamide or (meth)acrylamide-containing high Tg additive.

### BACKGROUND

In recent years, electronic components have increased in functionality and decreased in size and thickness. For example, many mobile devices have a thinner and frameless design so that they are easier to carry while also having a wider display screen. Oftentimes, pressure sensitive adhesives (PSAs) are used in the assembly of mobile device components to bond optical members such as lens, prisms, reflectors, or polarizers. PSAs have become required in order to have high adhesion to match the smaller area. in addition, curved surface design features are becoming more popular, which creates anti-repulsion demand. However, delamination due to anti-repulsion can occasionally occur with many PSAs, particularly at high temperatures or during thermal cycle tests.

One method of increasing high temperature resistance of a PSA in order to address the delamination issue is to synthesize a PSA with compatible high glass transition temperature (T_{g}) monomers on the polymer chain or to blend high softness temperature (Tₛ) tackifiers into the adhesive system. However, introducing high T_{g} monomers raises the T_{g} of the PSA which may change the peeling behaviors from smooth to shock peeling at high speed peeling rates. Moreover, loading high Tₛ tackifiers often results in cohesion deterioration, reducing the holding strength and creating aging stability issues (e.g. migration/yellowing). Therefore, balancing the adhesion and holding strength at elevated temperatures without sacrificing high peeling speed behavior while pursuing anti-repulsion property is a critical issue.

Various solutions have been proposed, including introduce lower molecular weight (M_{w}) acrylic polymers to substitute or blend with conventional tackifier resins to achieve desired adhesion performance without sacrificing other properties. In U.S. Pat. No. 7,927,703, an optically clear adhesive was blended with a high T_{g} polymer (T_{g}>20° C., M_{w} >100,000) to improve the blister issue on PMMA/PC lamination. In U.S. Pat. Nos. 8,410,218 and 8,470,931, acid-base interactions were disclosed by introducing amino group-containing high T_{g} (meth)acrylic polymers into a carboxylic PSA to improve the initial tack. In U.S. Pat. No. 9,803,114, it was disclosed that a lower M_{w} acrylic oligomer combined with general acrylic syrup as a skin adhesive of acrylic foam tape can improve the adhesion on certain substrates. The concept of blending different molecular weights (M_{w}), disclosed in U.S. Pat. No. 9,290,682, including both lower M_{w} commercially available tackifiers and high T_{g} acrylic polymers which are not entirely miscible and has shown a pathway to achieving improved adhesion and high temperature shear performance on low surface energy substrates. In U.S. Pat. No. 9,845,414, multilayer PSA assemblies are taught wherein at least a first PSA layer is superimposed on a second polymer layer, and the PSA layer includes a low T_{g} PSA and a high T_{g} (meth)acrylate copolymer (M_{w}>20,000) which can enhance the adhesion and shear performance on low surface energy substrates.

While most of the aforementioned patents focus on adhesion, anti-blister, and shear performances of PSAs, they do not discuss or address improvement of anti-lifting, creep, and adhesion at elevated temperatures.

### BRIEF DESCRIPTION OF THE DRAWINGS

The invention may be further illustrated by reference to the accompanying drawings wherein:

FIG. 1 is a schematic of an anti-repulsion test used in the present invention.

### SUMMARY

In one embodiment, the present application is a composition including a base resin comprising between about 4% and about 15% acrylic acid monomer and an oligomer additive including (a) one of an acrylamide or meth(acrylamide) copolymer and (b) a high glass transition temperature monomer. The oligomer additive has a molecular weight range of between about 20,000 and about 1,000,000 and a glass transition temperature of between about 70° C. and about 115° C. The composition has a blending ratio of base resin to oligomer additive of between about 7 and about 30 parts per hundred of resin.

In another embodiment, the present application is a pressure sensitive adhesive composition including between about 4 and about 15 parts acrylic acid monomer and between about 7 and about 30 parts an acrylamide or meth(acrylamide) copolymer based additive. The additive comprises a high glass transition temperature monomer and the additive has a molecular weight range of between about 20,000 and about 1,000,000 and a glass transition temperature of between about 70° C. and about 115° C.

### DETAILED DESCRIPTION

The present invention is an acrylic pressure sensitive adhesive (PSA) composition including an oligomer additive having a molecular weight (M_{w}) of greater than about 20,000 g/mol and a glass transition temperature (T_{g}) of greater than about 70° C. The acrylic PSA composition has enhanced peel creep, anti-lifting, and high-temperature shear resistance while exhibiting tack and peel adhesion properties. The acrylic PSA composition can be used in various areas, including, but not limited: to single-coated tapes, transfer tapes, double-coated tapes, skin adhesives, and tapes for the electronics market.

The acrylic PSA composition generally includes a base resin and an oligomer additive. The base resin includes an acrylic acid monomer. The acrylic acid monomer functions to aid in more uniform mixing of the oligomer additive with the base resin. In one embodiment, the acrylic PSA composition has a blending ratio of base resin to oligomer additive of between about 7 and about 25 parts per hundred of resin and particularly between about 10 and about 20 parts per hundred of resin. In one embodiment, the base resin includes between about 4% and about 10% and particularly between about 4% and about 8% acrylic acid monomer. The PSA with low T_{g} functions to aid in high adhesion and smooth peeling. In one embodiment, the base resin has a T_{g} of between about 0° C. and about −100° C., particularly between about −15° C. and about −75° C., and more particularly between about −35° C. and about −50° C.

Other materials can be added to the base resin for special purposes, including, for example: molecular weight control agents, coupling agents, plasticizers, heat stabilizers, adhesion promoters, UV stabilizers, UV absorbers, curing agents, polymer additives, photo-initiators, crosslinking agents, surface modifying agents, ultraviolet light stabilizers, antioxidants, antistatic agents, thickeners, fillers, thixotropic agents, processing aids, nanoparticles, and combinations thereof.

The oligomer additive includes (a) one of an acrylamide or meth(acrylamide) copolymer and (b) a high T_{g} monomer. The acrylamide or meth(acrylamide) copolymer of the oligomer additive provides H-bond interaction with the acid of the base resin. In one embodiment, the acrylamide or meth(acrylamide) copolymer can also have a high T_{g}. In one embodiment, the acrylamide or meth(acrylamide) comprises between about 1 and about 30 wt %, particularly between about 1.5 and about 25 wt %, and more particularly between about 1.5 and about 20 wt % of the oligomer additive.

The high T_{g} monomer provides high temperature resistance on anti-repulsion and high temperature shear. In one embodiment, the high T_{g} monomer is one of tert-butyl methacrylate, isobornyl acrylate, and cyclohexyl methacrylate. The high T_{g} monomer makes up the balance of the oligomer additive.

The M_{w}of the oligomer additive controls coating viscosity and anti-repulsion performance. If the M_{w} of the oligomer additive is too high, the higher coating viscosity may cause coating waviness. If the M_{w} of the oligomer additive is too low, poor anti-repulsion may appear. In one embodiment, the oligomer additive has a M_{w} range of between about 20,000 and about 1,000,000 g/mol, particularly between about 20,000 and about 950,000 g/mol, and more particularly between about 20,000 and about 700,000 g/mol. In one embodiment, the oligomer additive comprises between about 7 and about 25 wt %, particularly between about 10 and about 20 wt % of the base resin. The high T_{g} oligomer provides high temp resist on anti-repulsion and high temperature shear. In one embodiment, the oligomer additive has a T_{g} of between about 70° C. and about 115° C., particularly between about 90° C. and about 115° C.

The acrylic PSA composition of the present invention has good adhesion, hold time, and anti-lift. In one embodiment, the composition has an adhesion of at least about 11 N/cm on a polycarbonate substrate at about 70° C. when subjected to 180° peel test HS Z-0237/ISO 29862. In one embodiment, the composition has a holding time of at least about 6250 minutes on a polycarbonate substrate when subjected to ASTM D 3654 for static shear. In one embodiment, the acrylic PSA composition has substantially no lift when subjected to an anti-repulsion test. In one embodiment, the composition has a lower peeling distance of less than about 6 mm when subjected to the static creep test by hanging-weight of 90° peel orientation for the adhered tape at 70° C. on PC substrate. In one embodiment, the acrylic PSA composition has a holding time at 70C of at least about 10,000 min on PC substrate when subject to a high-temperature shear test.

In practice, the acrylic PSA composition can be positioned between a first substrate and a second substrate to form a laminate. The laminate includes the first substrate having at least one major surface, the second substrate having at least one major surface and the composition positioned adjacent the major surfaces of the first and second substrates. In one embodiment, at least one of the first and second substrates is optically clear and may include, for example, an optical film or optically clear substrate.

The laminate including the acrylic PSA composition can be used in a display assembly. The display assembly can further include another substrate (e.g., permanently or temporarily attached to the acrylic PSA composition), another adhesive layer, or a combination thereof. As used herein, the term “adjacent” can be used to refer to two layers that are in direct contact or that are separated by one or more thin layers, such as primer or hard coating. Often, adjacent layers are in direct contact. Additionally, laminates are provided that include the acrylic PSA composition positioned between two substrates, wherein at least one of the substrates is an optical film. Optical films intentionally enhance, manipulate, control, maintain, transmit, reflect, refract, absorb, retard, or otherwise alter light that impinges upon a surface of the film. Films included in the laminates include classes of material that have optical functions, such as polarizers, interference polarizers, reflective polarizers, diffusers, colored optical films, mirrors, louvered optical film, light control films, transparent sheets, brightness enhancement film, anti-glare, and anti-reflective films, and the like. Films for the provided laminates can also include retarder plates such as quarter-wave and half-wave phase retardation optical elements. Other optically clear films include anti-splinter films and electromagnetic interference filters.

In some embodiments, the resulting laminates can be optical elements or can be used to prepare optical elements. As used herein, the term “optical element” refers to an article that has an optical effect or optical application. The optical elements can be used, for example, in electronic displays, architectural applications, transportation applications, projection applications, photonics applications, and graphics applications. Suitable optical elements include, but are not limited to, glazing (e.g., windows and windshields), screens or displays, cathode ray tubes, and reflectors.

Exemplary optically clear substrates include, but are not limited to: a display panel, such as liquid crystal display, an OLED display, a touch panel, electrowetting display or a cathode ray tube, a window or glazing, an optical component such as a reflector, polarizer, diffraction grating, mirror, or cover lens, another film such as a decorative film or another optical film.

Representative examples of optically clear substrates include glass and polymeric substrates including those that contain polycarbonates, polyesters (e.g., polyethylene terephthalates and polyethylene naphthalates), polyurethanes, poly(meth)acrylates (e.g., polymethyl methacrylates), polyvinyl alcohols, polyolefins such as polyethylenes, polypropylenes, and cellulose triacetates. Typically, cover lenses can be made of glass, polymethyl methacrylates, or polycarbonate.

In other embodiments, either substrate can be a release liner. Any suitable release liner can be used. Exemplary release liners include those prepared from paper (e.g., Kraft paper) or polymeric material (e.g., polyolefins such as polyethylene or polypropylene, ethylene vinyl acetate, polyurethanes, polyesters such as polyethylene terephthalate, and the like). At least some release liners are coated with a layer of a release agent such as a silicone-containing material or a fluorocarbon-containing material. Exemplary release liners include, but are not limited to, liners commercially available from CP Film (Martinsville, VA) under the trade designation “T-30” and “T-10” that have a silicone release coating on polyethylene terephthalate film.

Choice of release liners obviously impact how strongly the adhesive sticks to the liner material. In some embodiments, adhesive layers with differing liner materials on two sides can be selected to make one surface release relatively easier than that liner from the other surface. In such case, we term the liner that releases more easily as affixed to the “easy-side” of the adhesive/liner stack and the liner that holds more tightly as affixed to the “tight-side” of the adhesive/liner stack.

The release liner can be removed to adhere the composition to another substrate (i.e., removal of the release liner exposes a surface of an adhesive layer that subsequently can be bonded to another substrate surface). Often, the acrylic PSA composition is permanently bonded to this other substrate, although in some cases the adhesion may be limited to allow for reworking of the display.

The oligomer additive of the present invention is prepared by a solvent polymerization process and is directly mixed with the solvent-based resin. The PSA and oligomer additive may also be prepared by any conventional free radical polymerization, including, but not limited to: radiation, bulk, dispersion, emulsion, and suspension process.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis.

TABLE 1
Materials Used in the Examples

| Abbreviation | Description and Source |
|---|---|
| Acm | Acrylamide, obtained from Sigma-Aldrich Company. |
| AA | Acrylic acid, obtained from Taiwan, Formosa |
| | Petrochemical Company. |
| tBMA | tert-butyl methacrylate, obtained from BASF. |
| CHA | Cyclohexyl acrylate, obtained from Tokyo, Japan, TCI. |
| CHMA | Cyclohexyl methacrylate, obtained from Tokyo, |
| | Japan, TCI. |
| DMAEMA | Diethylaminoethyl methacrylate, obtained from |
| | Tokyo, Japan, TCI. |
| DMAPMA | 3-Dimethylaminopropyl methacrylamide, obtained |
| | from Tokyo, Japan, TCI. |
| THFMA | Tetrahydrofurfuryl methacrylate, obtained from |
| | Tokyo, Japan, TCI. |
| NNDMA | N,N-Dimethylacrylamide, obtained from Kumamoto, |
| | Japan, Kohjin. |
| 2EHA | 2-Ethylhexyl acrylate, obtained from BASF. |
| IBOA | Isobornyl acrylate, obtained from Himeji, Japan, |
| | Nippon Shokubai. |
| nDM | normal-dodecyl mercaptan, obtained from Tokyo, Japan, |
| | TCI. |
| Vazo ®67 | 2,2′-azobis(2-methylbutylonitrile), obtained from |
| | Chemours. |
| MC591 | Bisamide corslinker, obtained from MN, USA, 3M. |

### Sample Tape

Each sample was prepared using a double coated tape strip composed of an adhesive layer laminated between two liner materials. The tape is constructed to have an easy-side (where the liner releases easily from the adhesive layer) and a tight side (where the liner holds more tightly to the adhesive layer). The easy-side liner is removed to allow for roll-lamination of the easy-side of the adhesive onto an 2 mil anodized aluminum strip (available from Lawrence & Fredrick, Stremwood, Ill. under the trade designation “5005 alloy H34 temper mill finish and/unsealed anodize aluminum”) as carrier and the tight-side liner is removed to allow for roll-lamination of the tight-side of the adhesive onto either SUS (cleaned by acetone/n-heptane) or PC substrate (cleaned by n-heptane).

### Test Methods

### 180° Peel Test on Stainless Steel (SUS) and Polycarbonate (PC). (JIS Z-0237/ISO 29862)

Each sample was prepared using a 1″ wide double coated tape strip. The easy-side liner was removed to allow for roll-lamination of the easy-side of the adhesive onto a 2 mil anodized aluminum strip as carrier. Next, the tight-side liner was removed to allow for roll-lamination of the tight-side of the adhesive to a substrate, either stainless steel (SUS) or polycarbonate (PC) The SUS substrates were first cleaned using acetone/n-heptane) and the PC substrates were first cleaned by n-heptane. Each finished sample—composed of a substrate, adhesive layer and 2-mil anodized aluminum strip laminate—was then left at ambient environment for 72 hours to equilibrate before testing.

The 180° peel test was conducted according to JIS Z-0237/ISO 29862 with the peel test speed set at 12 inches/minute. The average peel force was recorded in in ounces per inch width).

### Static Creep Test on Polycarbonate (PC)

Samples of 1″×4″ size were prepared by first removing the easy-side liner to allow for roll-lamination of the easy-side of the adhesive onto a 1-mil primed PET film. Next, the tight-side liner was removed to allow for roll-lamination of the tight-side of the adhesive to a PC substrate (cleaned by n-heptane). Samples were exposed to 70° C. for 10 minutes to stabilize. After this, the substrate of the sample was positioned horizontally while a 100 g weight was affixed to the PET film portion of the sample, hanging vertically to slowly peel the adhesive off the substrate (weight pulling by gravity at 90° to the substrate). The peel distance was recorded after being hung at 70° C. for 3 hours.

### Anti-repulsion Test on Polycarbonate (PC)

A 2 cm-wide, 18 cm-long piece was cut from the resulting pressure-sensitive adhesive tape, and the easy-side liner of the tape was removed to allow for roll-lamination of the easy-side of the adhesive layer onto an anodized aluminum plate of 2 cm-wide, 18 cm-long, 0.4 mm-thickness. Next, the tight-side liner was removed to allow for roll-lamination of the tight-side of the adhesive layer onto a middle of PC substrate with 3 cm-wide, 20 cm-long, 2 mm thickness. The revealed adhesive layer was rolled once in each direction during the roll-lamination at 12 mm/min. The resultant sample—composed of aluminum plate, adhesive, PC substrate—was exposed to 23° C./50% relative humidity for 24 hours to equilibrate.

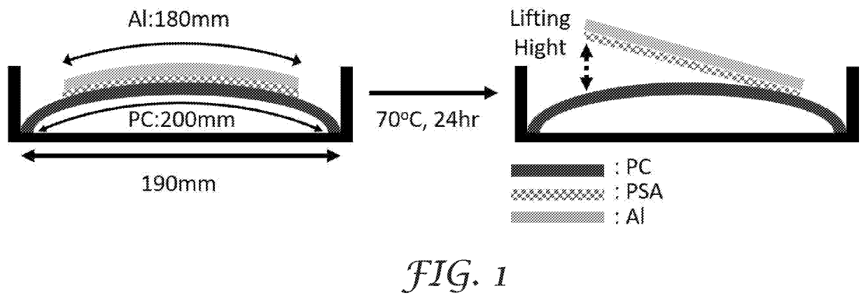

Each sample was tested in a bending jig at elevated temperature to test for failures of lamination that would cause the anodized A1 plates to lift from the polycarbonate layer (PC). The bending jig consisted of a 19 cm box designed to constrain one end of the 20 cm long PC/aluminum plate sample such that the 20 cm long sample was held in the shape of an arc with PC side down and A1 plate side one the outer surface of the arc (FIG. 1). The bending jig was placed at 70° C. oven for 24 hours, the height (mm) of the sample end lifting from the surface of the adherend was measured. The heights of both lifting ends of the sample were averaged. The average was used as the lifting height (mm) for evaluation. It should be noted that it is preferable to use as many samples as possible when the average is calculated.

### Static Shear Performance Test on SUS and PC (ASTM D 3654)

A 1″×1″ tested double coated tape strip was cut. The easy-side liner of the tape was removed to allow for roll-lamination of the easy-side of the adhesive onto an 2 mil anodized aluminum strip. Next the tight-side liner of the tape was removed to allow for roll-lamination of the tight-side of the adhesive onto either SUS (cleaned by acetone/n-heptane) or PC substrate (cleaned by n-heptane). The sample was mounted on a hook with timer panel in a 70° C. oven and a 1 kg weight was applied (weight pulling by gravity at 180° to the substrate). The timer was then started, as the tape peeled off from the substrate, the hanging weight would trip a switch and stop the timer. The time to peel a set length of tape was recorded.

### Preparatory Examples

TABLE 2
Oligomer example

| | tBMA | CHMA | IBOA | NNDMA | Acm | DMAPMA | Vazo67 | NDM | EAC | Mw | Tg |
|---|---|---|---|---|---|---|---|---|---|---|---|
| | (g) | (g) | (g) | (g) | (g) | (g) | (g) | (g) | (g) | (g/mol) | (° C.) |
| EX1 | 47.8 | | 24 | 8 | | | 0.24 | 0.24 | 120 | 71294 | 107.5 |
| EX2 | 71.8 | | | 8 | | | 0.24 | 0.8 | 120 | 36963 | 114.9 |
| EX3 | 55.8 | | 8 | 16 | | | 0.24 | 0.24 | 120 | 83987 | 109.4 |
| EX4 | | | 63.8 | 16 | | | 0.24 | | 120 | 943510 | 93 |
| EX5 | 78.2 | | | | 1.6 | | 0.24 | 0.24 | 120 | 69454 | 118.8 |
| EX6 | | 78.2 | | | 1.6 | | 0.24 | | 120 | 465822 | 93.2 |
| EX7 | | 78.2 | | | 1.6 | | 0.24 | 0.08 | 120 | 88335 | 93.2 |
| EX8 | 38.3 | | 39 | | 2.4 | | 0.24 | 0.24 | 120 | 68035 | 103.4 |
| EX9 | 33.1 | | 45.5 | | | 1.2 | 0.24 | 0.24 | 120 | 35762 | 104.2 |
| EX10 | 45.5 | | 32.7 | | | 1.6 | 0.24 | 1.2 | 120 | 20847 | 114.3 |
| EX11 | | 40 | 38.3 | | | 1.6 | 0.24 | 0.08 | 120 | 230195 | 93.7 |
| EX12 | | 40 | 38.3 | | | 1.6 | 0.24 | 0.24 | 120 | 78356 | 93.7 |
| EX13 | 44.7 | | 32.7 | | | 2.4 | 0.24 | 0.16 | 120 | 32026 | 108.2 |

As an illustrative example, for EX2, 71.8 g of tBMA, 8 g of NNDMA, and 120 g of ethyl acetate were added into a glass vial with the addition of 0.24 g of Vazo® 67 and 0.8 g of NDM, and under nitrogen gas flow to remove oxygen in the polymerization system. The mixture polymerized at 60° C. for 24 hours. Upon completion of the reaction, the product has a Mw weight of 36,963 g/mol.

### Comparative Examples

TABLE 3
Comparative examples

| | tBMA | IBOA | THFMA | CHA | NNDMA | Acm | DMAPMA | AA | Vazo67 | NDM | EAC | Mw | Tg |
|---|---|---|---|---|---|---|---|---|---|---|---|---|---|
| | (g) | (g) | (g) | (g) | (g) | (g) | (g) | (g) | (g) | (g) | (g) | (g/mol) | (° C.) |
| C1 | | | 77.4 | | | 2.4 | | | 0.24 | 0.24 | 120 | 113140 | 62.4 |
| C2 | | | | 67.8 | 12 | | | | 0.24 | 0.24 | 120 | 125450 | 27.7 |
| C3 | 77.4 | | | | | | | 2.4 | 0.24 | 0.12 | 120 | 96718 | 117.6 |
| C4 | 71.8 | | | | | | | 8 | 0.24 | 0.06 | 120 | 129470 | 115.5 |
| C5 | 39 | 39 | | | | | 1.6 | | 0.24 | 1.2 | 120 | 17163 | 106.1 |
| C6 | 39 | 39 | | | | | 1.6 | | 0.24 | 2.4 | 120 | 11050 | 106.1 |

As an illustrative example, for C2 sample, 67.8 g of CHA, 12 g of NNDMA, and 120 g of ethyl acetate were added into a glass vial with the addition of 0.24 g of Vazo®67 and 0.24 g of NDM, and under nitrogen gas flow to remove oxygen in the polymerization system. The mixture polymerized at 60° C. for 24 hours. Upon completion of the reaction, the product has a Mw weight of 125,450 g/mol.

TABLE 4
Basic pressure sensitive adhesive

| | 2EHA | IBOA | AA | Vazo67 | EAC | M_{w} | T_{g} |
|---|---|---|---|---|---|---|---|
| | (g) | (g) | (g) | (g) | (g) | (g/mol) | (° C.) |
| PSA1 | 74.9 | | 4.8 | 0.24 | 120 | 534,520 | −50.6 |
| PSA2 | 71.9 | | 8 | 0.12 | 120 | 806,360 | −40.5 |
| PSA3 | 68.7 | 8 | 3.2 | 0.24 | 120 | 451,710 | −35.8 |

For PSA 1 sample, 74.9 of 2EHA, 4.8 parts of AA, and 120 g of ethyl acetate were added into a glass vial with the addition of 0.24 g of Vazo®67, and under nitrogen gas flow to remove oxygen in the polymerization system. The mixture polymerized at 60° C. for 24 hours. Upon completion of the reaction, the product has M_{w} weight of 534,520 g/mol.

TABLE 5
Different loading amount of blending acrylic additive and PSA

| | PSA + Additive | Loading (phr) |
|---|---|---|
| Blen1 | EX1 + P3 | 20 |
| Blen2 | EX2 + P2 | 7 |
| Blen3 | EX3 + P3 | 10 |
| Blen4 | EX4 + P3 | 10 |
| Blen5 | EX5 + P1 | 10 |
| Blen6 | EX6 + P1 | 20 |
| Blen7 | EX7 + P2 | 15 |
| Blen8 | EX8 + P2 | 10 |
| Blen9 | EX9 + P1 | 20 |
| Blen10 | EX10 + P1 | 20 |
| Blen11 | EX11 + P3 | 20 |
| Blen12 | EX12 + P1 | 25 |
| Blen13 | EX13 + P1 | 20 |
| Blen 14 | C1 + P2 | 10 |
| Blen 15 | C2 + P1 | 20 |
| Blen 16 | C2 + P3 | 15 |
| Blen 17 | C3 + P1 | 20 |
| Blen 18 | C4 + P2 | 15 |
| Blen 19 | C5 + P1 | 20 |
| Blen 20 | C6 + P1 | 20 |

The adhesive solutions of Examples 1 to 13, and Comparative examples 1 to 6 were prepared by mixing the components listed in Table 5.

100 Parts by weight of PSA P3, 20 parts by weight of the acrylic polymer additive EX1, and 0.1 part by weight of a bisamide crosslinker crosslinking agent (MC591) were blended. The resultant composition was coated on a silicone-coated 38 μm thick PET film for 70 μm dry thickness adhesive. Then the adhesive was laminated on both sides of 12 micrometer thick PET film (available from NanYa).

The obtained adhesive solution was coated on the polyethylene terephthalate (PET) release liner with knife coating to make 70 micrometer thick adhesive after drying. Then, dried and crosslinked at 90° C. for 10 minutes. The adhesive was then laminated on both sides of 12 micrometer thick PET film (available from NanYa).

Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows. All references cited in this disclosure are herein incorporated by reference in their entirety.

What is claimed is:

1. A composition comprising:
a base resin comprising between about 4% and about 15% acrylic acid monomer; and
an oligomer additive comprising (a) one of an acrylamide or meth(acrylamide) copolymer and (b) a high glass transition temperature monomer,
wherein the oligomer additive has a molecular weight range of between about 20,000 and about 1,000,000 and a glass transition temperature of between about 70° C. and about 115° C., and
wherein the composition has a blending ratio of base resin to oligomer additive of between about 7 to about 30 parts per hundred of resin.

2. The composition of claim 1, wherein the composition comprises between about 4% and about 10% acrylic acid monomer.

3. The composition of claim 1, wherein the composition has a blending ratio of base resin to oligomer additive of between about 7 to about 25 parts per hundred of resin.

4. The composition of claim 1, wherein the oligomer additive has a molecular weight range of between about 20,000 and about 950,000.

5. The composition of claim 1, wherein the oligomer additive has a glass transition temperature of between about 90° C. and about 115° C.

6. The composition of claim 1, wherein the high T_{g} monomer is one of tert-butyl methacrylate, isobornyl acrylate, and cyclohexyl methacrylate.

7. The composition of claim 1, wherein the base resin has a glass transition temperature of between about −35° C. and about −50° C.

8. The composition of claim 1, wherein the composition has a holding time of at least about 6250 minutes on a polycarbonate substrate when subjected to ASTM D 3654 for static shear.

9. The composition of claim 1, wherein the composition has an adhesion of at least about 11 N/cm on a polycarbonate substrate at about 70° C. when subjected to 180° peel test JIS Z-0237/ISO 29862.

10. A pressure sensitive adhesive composition comprising:
between about 4 and about 15 parts acrylic acid monomer; and
between about 7 and about 30 parts an acrylamide or meth(acrylamide) copolymer based additive, wherein the additive comprises a high glass transition temperature monomer, and
wherein the additive has a molecular weight range of between about 20,000 and about 1,000,000 and a glass transition temperature of between about 70° C. and about 115° C.

11. The pressure sensitive adhesive of claim 10, wherein the composition comprises between about 4 and about 10 parts acrylic acid monomer.

12. The pressure sensitive adhesive of claim 10, wherein the additive has a molecular weight range of between about 20,000 and about 950,000.

13. The pressure sensitive adhesive of claim 10, wherein the composition comprises between about 7 to about 25 parts acrylamide or meth(acrylamide) copolymer based additive.

14. The pressure sensitive adhesive of claim 10, wherein the additive has a glass transition temperature of between about 90° C. and about 115° C.

15. The pressure sensitive adhesive of claim 10, wherein the high T_{g} monomer is one of tert-butyl methacrylate, isobornyl acrylate, and cyclohexyl methacrylate.

16. The pressure sensitive adhesive of claim 10, wherein the composition has a holding time of at least about 6250 minutes on a polycarbonate substrate when subjected to ASTM D 3654 for static shear.

17. The pressure sensitive adhesive of claim 10, wherein the composition has an adhesion of at least about 11 N/cm on a polycarbonate substrate at about 70° C. when subjected to 180° peel test JIS Z-0237/ISO 29862.
